(19) United States
(12) Patent Application Publication
(10) Pub. No.: US 2004/0024586 A1
(43) Pub. Date: Feb. 5, 2004

(54) Methods and apparatuses for capturing and wirelessly relaying voice information for speech recognition

(76) Inventor: David B. Andersen, Hillsboro, OR (US)

Correspondence Address: INTEL CORPORATION, P.O. BOX 5326, SANTA CLARA, CA, 95056-5326, US

(21) Appl. No.: 10/210,601

(22) Filed: Jul. 31, 2002

(51) Int. Cl. G10L 11/00

(52) U.S. Cl. 704/200

(57) ABSTRACT

A speech recognition system includes a transducer placed in direct physical contact with the user. When the user speaks, the transducer receives the speech signal from the user based on its contact with the user instead of receiving the speech signal through free air. The transducer generates an analog electrical audio signal corresponding to the speech signal. The analog electrical audio signal is then converted to a digital audio signal and transmitted to a speech recognition engine using a wireless connection. By placing the transducer in direct physical contact with the user, ambient noise in the free air may be reduced and speech recognition accuracy may be improved.

### FIELD OF THE INVENTION

The present invention generally relates to the field of computer systems, and more specifically relating to methods and apparatuses for capturing speech signals.

### BACKGROUND

Computer systems are becoming increasingly pervasive in our society, including everything from small handheld electronic devices, such as personal data assistants, cellular phones, and headset microphones, to application-specific electronic devices, such as set-top boxes, digital cameras, and other consumer electronics, to medium-sized mobile systems such as notebook, sub-notebook, and tablet computers, to desktop systems, workstations, and servers.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur.

Generally, sound waves are mechanical variations in air pressure. Sound waves can be converted to electrical variations using an electro-acoustical transducer such as a microphone. In a speech recognition system, a microphone receives a speech signal from a user. The user's speech signal travels outward from the user in free air as sound waves of varying air pressure. The microphone generates an analog electrical audio signal corresponding to the variations in air pressure which comprise the speech signal. The electrical audio signal is then converted to a digital audio signal, typically pulse code modulation (PCM) samples, where it can be further processed and analyzed by digital computing elements.

The microphone may be connected to a computer system using a communication port such as a universal serial bus (USB) port. The computer system may need to be trained so that it recognizes characteristics of the user's voice before it can adequately translate the digital representation of the speech signal into text. One disadvantage of receiving the user's speech signal in the free air is that, in addition to the user's speech signal, the microphone also receives ambient noise generated by sources other than the user. In typical home environments, ambient noise sources such as small kitchen appliances, vacuum cleaners, dish washers, etc. can be very loud resulting in a low signal to noise ratio.

There are different techniques to filter out the ambient noise. One technique includes using digital noise cancellation technology in microphones. For example, the IBM ViaVoice for Windows Pro USB Edition speech recognition product by IBM Corporation of White Plains, N.Y. includes a USB headset microphone that includes a digital signal processor for higher speech recognition accuracy. Another technique includes using mechanical and/or electronic means to limit the directions from which sound will be picked up by the microphones. These techniques, called beam forming, reject noise signals by receiving sound energy only from a source when it is directly in front of the microphone. Finally, the simplest but least practical technique, is to simply eliminate ambient noise by using acoustically controlled environments such as a sound proof room.

### BRIEF DESCRIPTION OF THE DRAWINGS

The following drawings disclose various embodiments of the present invention for purposes of illustration only and are not intended to limit the scope of the invention.

FIG. 1 is a block diagram illustrating an example of a computer system that includes a transducer in accordance to one embodiment of the present invention.

FIG. 2 is a block diagram illustrating one embodiment of a speech recognition system using a transducer and a host system.

FIG. 3 is a flow diagram illustrating one embodiment of a speech recognition process based on a user's speech signal received using a transducer placed in direct contact with the user.

### DETAILED DESCRIPTION

Methods and an apparatuses for performing speech recognition by using speech signal received from direct physical contact with a user are disclosed. In one embodiment, speech signal from a user is received by a placing a transducer in physical contact with the user. The transducer generates an electrical audio signal corresponding to the speech signal. The electrical audio signal is then converted to a digital audio signal for processing.

According to one embodiment, the speech signal received from direct contact may have different temporal and spectral characteristics from the same speech signal received through free air. In addition, the transducer used to receive the speech signal by direct physical contact may be different from the typical microphone used to receive the speech signal through free air. As the user (or person) speaks, the transducer according to one embodiment receives the speech signal by sensing vibrations caused by speech that naturally occur on certain parts of the body such as the head and throat. The electrical audio signal generated by the direct-contact transducer may be different from the electrical audio signal generated by a microphone that receives the user's corresponding speech signal through free air. However, by placing the transducer in direct physical contact with the user, ambient noise in the free air may be greatly reduced yielding a much improved signal to noise ratio. This in turn results in improved speech recognition accuracy.

A variety of transducer designs may be employed for the purposes of this invention. One example of a transducer that is known to work well is the fairly large diameter diaphragm used in a stethoscope. Transducers similar to those employed for ultrasound imaging may also prove to be effective.

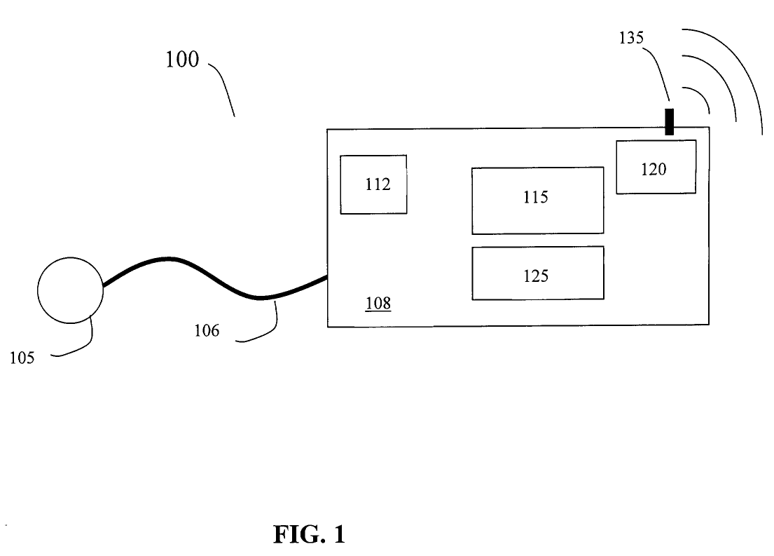

FIG. 1 is a block diagram illustrating an example of a computer system that includes a transducer in accordance to one embodiment of the present invention. The computer system 100 may be a portable system that, for example, can be used to receive speech signal from a user (not shown) and to output a corresponding digital audio signal. The computer system 100 may include a transducer 105. The transducer 105 may be used to receive the speech signal from the user when it is placed in contact with the user. The transducer 105 may generate an electrical audio signal corresponding to the speech signal. The transducer 105 may be coupled to an integrated circuit (IC) 108 using connection 106. The electrical audio signal generated by the transducer 105 may be sent to the circuit 108 for processing.

The circuit 108 may include a battery 112. The circuit 108 may also include logic to receive the electrical audio signal from the transducer 105 and to convert the electrical audio signal into a corresponding digital audio signal. For example, the circuit 108 may include a processor 115 and a memory 125. The memory 125 may be random access memory (RAM), read only memory (ROM), a persistent storage memory, such as mass storage device or any combination of these devices. The processor 115 may execute sequences of instructions stored in the memory 125 to convert the electrical audio signal received from the transducer 105 into the digital audio signal (e.g., PCM samples).

In one embodiment, the circuit 108 may also include a communication interface 120. The communication interface 120 may be used to transmit the digital audio signal to a host computer system (not shown) for processing. In one embodiment, the communication interface 120 may be coupled to an antenna 135, and the transmission of the digital audio signal to the host computer system may be carried out using a wireless connection (e.g., 802.11b, Bluetooth, etc.). The digital audio signal may be stored in the memory 125 while an utterance is occurring. Once the utterance ends, stored samples may then be quickly relayed to the host computer system via the wireless link for speech recognition processing, thereby reducing the amount of time that the wireless link needs to remain active. Although the computer system 100 in FIG. 1 illustrates the transducer 105 as being coupled to the circuit 108 by the connection 106, it may be implemented to be part of the circuit 108. Furthermore, instead of the circuit 108, other battery battery-powered digital transmitter circuit implementation may also be used to perform the functions described.

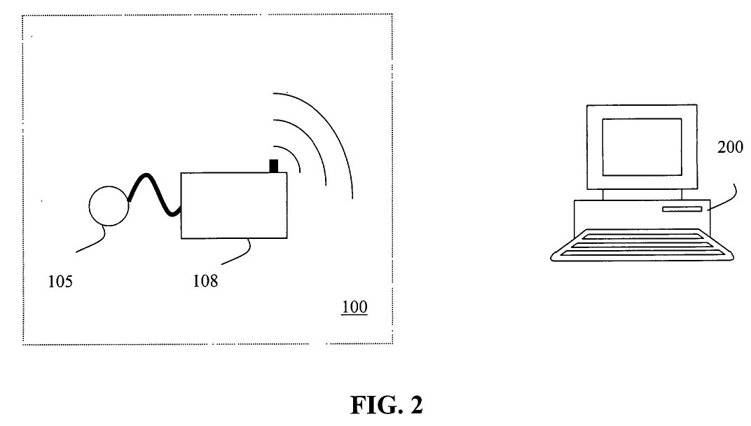

FIG. 2 is a block diagram illustrating one embodiment of a speech recognition system using the computer system illustrated in FIG. 1 and a host system. Host system 200 may include a communication interface (not shown) to receive the digital audio signal from the computer system 100 using, for example, a wireless connection. The host system 200 may include logic to apply digital filtering and equalization on the digital audio signal to compensate for characteristics of the transducer 105. The host system 200 may then present the digital audio signal as input to a speech recognition engine (not shown). The speech recognition engine may, for example, use a database (not shown) that stores the user's speech patterns to help with the process of recognizing the digital audio signal and translating it into text. In one embodiment, the host system 200 may need to be trained to learn the user's speech pattern. For example, the user may place the transducer 105 in contact with the user's forehead and then may read several predetermined sample lines of text. This allows the host system 200 to learn the user's speech pattern and to adapt to the spectral and temporal characteristics of the speech signal.

The transducer 105 according to one embodiment of the present invention may be placed in contact with the user at, for example, the user's throat, forehead, behind ear, etc. The contact may be made with the help of a strap-like device that is designed to include the transducer 105 and the circuit 108 as illustrated in FIG. 2. For example, the transducer 105 may be attached to a sweatband of a baseball cap where it would make good contact with the forehead of a user. The circuit 108 may be enclosed in a thin housing and may be inserted into the lining of the cap. An activating switch may be imbedded in the visor of the cap. When a user wants to communicate with a host computer system 200, the user may place on the cap and may activate the switch imbedded in the visor of the cap to establish a communication session with the host system. When the user speaks, the user's speech signal would then be received by the transducer 105 based on its direct contact with the user's forehead. This is instead of receiving the user's speech signal from the free air. The digital audio signal corresponding to the user's speech signal is then relayed by the circuit 108 to the host system. The communication between the user using the baseball cap and the host system may be carried out with far less constraint on the user's mobility than with other methods.

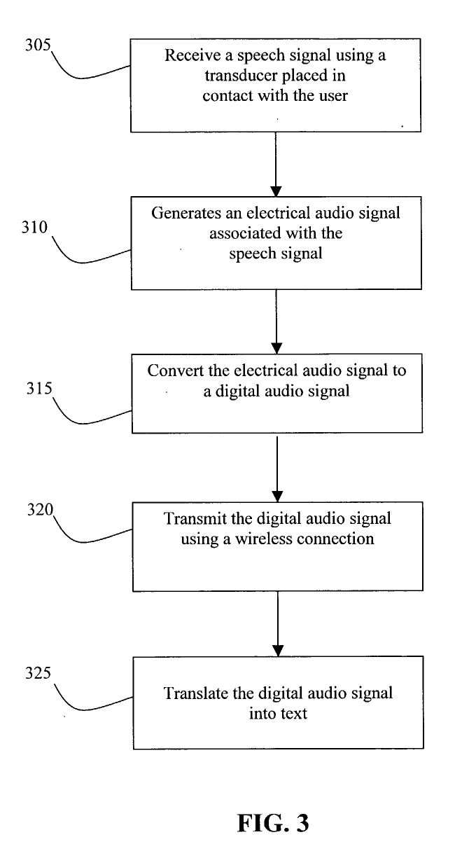

FIG. 3 is a flow diagram illustrating one embodiment of a speech recognition process based on a user's speech signal received using a transducer 105 placed in contact with the user. The transducer 105 may be placed in contact with the user using, for example, a baseball cap attached with the transducer 105 as described above. At block 305, the speech signal is received from the user by the transducer 105 placed in contact with the user. At block 310, the transducer 105 generates an electrical audio signal based on the speech signal. At block 315, the electrical audio signal is converted to a digital audio signal. At block 320, the digital audio signal is transmitted to a host system using a wireless communication connection. At block 325, the digital audio signal is translated into text by the host system.

Thus, methods and apparatuses for speech recognition have been described. Embodiments of the present invention provide improvement over the prior art techniques, while also delivering several distinct advantages. For example, it may not be necessary to use expensive transducers or any beam forming electronics to perform speech recognition. Additionally, it may not be necessary to impose any acoustical requirements upon the rooms in which the transducer in accordance to one embodiment is used. Furthermore, using the transducer in accordance to one embodiment of the invention allows the user to be able to move about a room at will without cables or wires to constrain movement.

Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A method for facilitating speech recognition, comprising:
receiving a speech signal from a person by placing a transducer in direct physical contact with the person; and
transmitting a digital audio signal associated with the speech signal to a host system for speech recognition using a wireless connection.

2. The method of claim 1, further comprising:
generating an electrical audio signal from the speech signal; and
converting the electrical audio signal to the digital audio signal.

3. The method of claim 1, further comprising:
training the host system to learn speech patterns of the person and adapting to the spectral and temporal characteristics of the speech signal.

4. The method of claim 3, wherein training the host system comprises placing the transducer in direct physical contact with the person while the person reads predetermined lines of text.

5. The method of claim 1, wherein placing the transducer in contact with the person comprises placing the transducer at the person's forehead or throat.

6. An apparatus, comprising:
a transducer to receive a speech signal from a user when the transducer is placed in contact with the user, the transducer generating an electrical audio signal associated with the speech signal received from the user; and
a circuit coupled to the transducer, the circuit to receive the electrical audio signal from the transducer, to convert the electrical audio signal to a digital audio signal, and to transmit the digital audio signal using a wireless connection.

7. The apparatus of claim 6, wherein the circuit comprises a processor and a memory coupled to the processor, wherein the processor performs instructions stored in the memory to convert the electrical audio signal to the digital audio signal.

8. The apparatus of claim 7, wherein the digital audio signal comprises pulse code modulation (PCM) samples.

9. The apparatus of claim 8, wherein the PCM samples are stored in the memory, and wherein the circuit transmitting the digital audio signal comprises the circuit transmitting the PCM samples.

10. The apparatus of claim 9, wherein the circuit transmits the PCM samples to a host system using the wireless connection when there is no utterance.

11. The apparatus of claim 10, wherein the host system performs speech recognition using the PCM samples.

12. A speech recognition system, comprising:
a transducer to receive a speech signal from a user when the transducer is placed in direct physical contact with the user, the transducer generating an electrical audio signal associated with the speech signal received from the user, wherein digital audio signal associated with the electrical audio signal is transmitted to a speech recognition engine using a wireless connection.

13. The system of claim 12, further comprising a circuit coupled to the transducer, the circuit comprises logic to convert the electrical audio signal to the digital audio signal.

14. The system of claim 13, wherein the circuit further comprises logic to transmit the digital audio signal to the speech recognition engine using the wireless connection.

15. The system of claim 14, wherein the speech recognition engine is trained to adapt to spectral and temporal characteristics of the speech signal obtained via direct physical contact, and trained to learn speech patterns of the user in order to translate the digital audio signal into text.

16. An apparatus, comprising:
a speech recognition engine to translate a digital audio signal received from a wireless connection into text, the digital audio signal associated with a speech signal generated by a user, wherein the speech signal is received from the user using a transducer placed in direct physical contact with the user.

17. The apparatus of claim 16, wherein the speech recognition engine is trained to learn speech patterns of the user by placing the transducer in contact with the user while the user reads predetermined lines of text.

18. The apparatus of claim 17, wherein the speech recognition engine is further trained to adapt to spectral and temporal characteristics of the speech signal obtained via the direct physical contact.

19. The apparatus of claim 16, wherein the wireless connection is implemented using Bluetooth or 802.11b communication protocol.

20. The apparatus of claim 16, wherein the digital audio signal is received from the wireless connection when there is no utterance.
